(19) United States
(12) Patent Application Publication
(10) Pub. No.: US 2005/0275761 A1
(43) Pub. Date: Dec. 15, 2005

(54) REAR PROJECTION TYPE TELEVISION WITH REDUCED CABINET DEPTH

(76) Inventors: Yi Wei Liu, Taipei Hsien (TW); Po Liang Chiang, Taipei City (TW); Hsueh Chen Chang, I-Lan Hsien (TW); Hsin Wen Tsai, Taipei Hsien (TW); Ci Guang Peng, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 10/709,981

(22) Filed: Jun. 10, 2004

(51) Int. Cl. H04N 5/64

(52) U.S. Cl. 348/789

(57) ABSTRACT

A rear projection type television having an improved projection lens system is provided. The projection lens system includes a projection lens with a central light axis at its center that is offset from a reference horizontal line. The offset projection lens projects a central light beam through two reflection mirrors that are not parallel with each other to an image projection surface of a front screen. The image projection surface of a front screen is normal to the horizontal line.

### BACKGROUND OF INVENTION

1. Field of the Invention

The present invention relates to the field of rear-projection type televisions. More particularly, the present invention relates to a rear-projection type television with reduced cabinet depth (thickness). The present invention is characterized in that two reflective mirrors, which are disposed between an inclined projection lens and a screen of the rear-projection type television, are arranged deliberately not in parallel with each other.

2. Description of the Prior Art

Projection televisions (TVs) are known in the art. In contrast to conventional TVs, projection TVs form a small image on a device inside the projector—either a CRT or LCD—and then shine that image onto a large screen located elsewhere. In one type of projection TV, the screen is located within the TV box/cabinet itself. This type of projection TV is called a rear- or reflective projection. In this type, light reflects off the projection display panel and is then projected onto the screen.

Some exemplary high-resolution digital projection TVs available today includes DLP (digital light processing), LCoS (Liquid Crystal on Silicon), and HTPS LCD type TVs. Among the aforesaid three types, the DLP type projection TV typically has the thinnest TV cabinet depth/thickness and the three-panel LCoS type projection TV has the largest cabinet depth/thickness. LCoS type projection TVs may be further divided into two categories: single-mirror system and dual-mirror system, in terms of the number of reflective mirror(s) disposed between the projection lens and the TV screen. Typically, the depth/thickness of the TV cabinet equipped with a dual-mirror system is thinner than the depth/thickness of the TV cabinet equipped with a single-mirror system. It is also known in the art that the conventional LCoS rear-projection TVs with dual-mirror system include two reflective mirrors that are in parallel with each other in order to avoid image distortion.

FIG. 1 is a cross-sectional view schematically showing the disposal of reflective mirrors, screen, optical engine, and the projection lens within a conventional dual-mirror system rear-projection TV. The conventional rear-projection TV mainly comprises a screen 10 in the front, a base 11 at the bottom, and a rear cover 12 at the backside constitute the interior of the rear-projection TV. The interior of the rear projection TV has a carrier 13 on the base 11, and the carrier 13 has an optical engine 14 on it. A first mirror 15 is fixed in the front of a projection lens 24 of the optical engine 14, and a second mirror 16 is disposed on the inner side of the rear cover 12 at the back of the screen 10. The operation of the optical system of the rear projection television is by means of generating a beam with video information from the optical engine 14 on the carrier 13 and projecting the beam onto the first mirror 15. The beam is then reflected onto the second mirror 16 from the first mirror 15, and finally onto the screen 10. Every component of the optical system of the rear projection television must have an accurate relative position and a projection angle to assure the distortion-free and aberration-free image produced by the optical system of the rear projection TV. As aforementioned, it is important to have the mirrors 15 and 16 be arranged in parallel with each other to prevent the image distortion. Besides, the projection lens of the above-described prior art rear-type projection TV is not offset with respect to its optical axis. Further, the center optical axis of the projection lens is normal to the active surface of the LCoS or LCD panels (not explicitly shown) installed in the optical engine 14 according to the prior art.

Furthermore, as specifically indicated in FIG. 1, a central light beam 26 carrying video information emanated from a center of the projection lens 24 of the optical engine 14 is reflected by the mirror 15, then reflected by the mirror 16, and is projected at a normal angle (90°) to the surface of the screen 10. The central light beam 26 propagates along the center optical axis of the projection lens 24.

To save the room space, it is often desirable that the depth/thickness of the projection TV cabinet is reduced as thin as it can. However, the above-described conventional configuration with two parallel reflective mirrors limits the reduction of the depth/thickness of the rear-projection TV cabinet.

### SUMMARY OF INVENTION

It is therefore the primary object of the present invention to provide a rear-projection type television with reduced cabinet depth/thickness, thereby saving room space.

It is another object of the present invention to provide a projection lens system of a rear-projection type television equipped with two reflective mirrors that are not in parallel with each other.

According to the claimed invention, a projection lens system of a rear-projection type television is provided. The projection lens system includes a screen having an image projection surface that is normal to a horizontal reference line; and a projection lens component having a center optical axis that is obliquely offset with respect to the horizontal reference line. The projection lens component is disposed in front of the screen. A first mirror is disposed between the screen and projection lens component. A second mirror is disposed on the light path between the first mirror and the screen for reflecting an image reflected from the first mirror onto the screen. The second mirror is not in parallel with the first mirror.

Other objects, advantages, and novel features of the claimed invention will become more clearly and readily apparent from the following detailed description when taken in conjunction with the accompanying drawings.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a cross-sectional view schematically showing the disposal of the reflective mirrors, screen, optical engine, and the projection lens within a dual-mirror system rear-projection TV cabinet according to the prior art; and

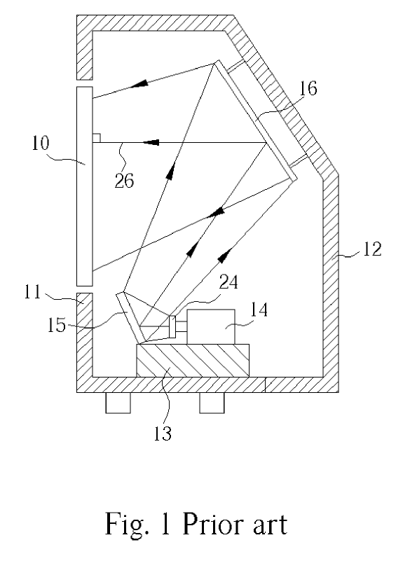

FIG. 2 is a schematic cross-sectional diagram showing the disposal of a projection lens system with two reflective mirrors inside a rear-type projection TV cabinet in accordance with one preferred embodiment of this invention.

### DETAILED DESCRIPTION

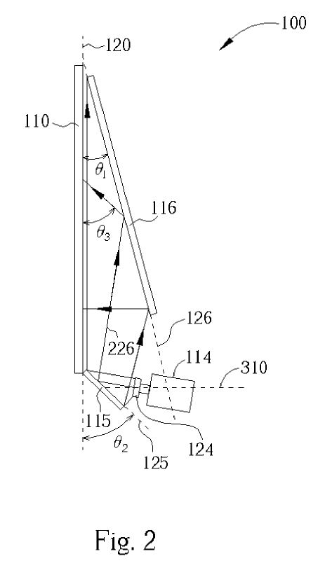

Please refer to FIG. 2. FIG. 2 is a schematic cross-sectional diagram showing the disposal of a projection lens system 100 with two reflective mirrors inside a rear-type projection TV cabinet in accordance with one preferred embodiment of this invention. It should be understood that the housing or cabinet of the rear-type projection TV is not shown in FIG. 2 for the sake of simplicity. The projection lens system 100 comprises the screen, the projection lens, and the two reflective mirrors. The relative positions of these parts are emphasized. As shown in FIG. 2, the rear-projection type TV comprises a screen 110, an optical engine 114 having a projection lens 124 that is obliquely offset from a horizontal reference line 310 (as indicated with the dash line), and mirrors 115 and 116 disposed approximately between the screen and the projection lens 124. The mirrors 115 and 116 are arranged deliberately not in parallel with each other.

As shown in FIG. 2, the screen 110 has a substantially flat image projection surface 120. The horizontal reference line 310 is normal to the image projection surface 120 of the screen 110. The mirror 115 has a reflection surface 125. The mirror 116 has a reflection surface 126. The surface area of the reflection surface 126 is larger than the surface area of the reflection surface 125. The reflection surface 126 is disposed at an acute angle Θ₁ with respect to the vertically disposed image projection surface 120. The reflection surface 125 is disposed at an acute angle Θ₂ with respect to the image projection surface 120. Since the mirrors 115 and 116 are not in parallel with each other, angle Θ₁ is therefore not equal to angle Θ₂. According to the preferred embodiment, angle Θ₁ is preferably smaller than angle Θ₂, wherein angle Θ₁ ranges between 15° and 40°, and more preferably between 25° and 35°. It is noteworthy that the center optical axis of the projection lens 124 is deliberately disposed at an inclined angle with respect to the horizontal reference line 310.

As indicated in FIG. 2, a center light beam 226 emanated from a center of the projection lens 124 propagates along the center optical axis of the offset projection lens 124. The center light beam 226 is first reflected by the reflection surface 125 of the mirror 115, then reflected by the reflection surface 126 of the mirror 116, and is eventually projected onto the image projection surface 120 of the screen 110 at an acute angle Θ₃. It is noteworthy that the inclined projection lens 124 remedies the image distortion due to the non-parallel arrangement of the mirrors 115 and 116. Compared to the prior art configuration, the incident center light beam 226 is not normal to the image projection surface 120. Further, in accordance with the preferred embodiment of this invention, each of the liquid crystal panels such as LCoS panels installed within the optical engine 114 is not normal to the center optical axis. Preferably, the liquid crystal panels are normal to the horizontal reference line 310 and are offset.

Those skilled in the art will readily observe that numerous modifications and alterations of the present invention may be made while retaining the teachings of the invention. Accordingly, the above disclosure should be construed as limited only by the metes and bounds of the appended claims.

1. A projection lens system of a rear-projection type television, comprising:
a screen having an image projection surface that is normal to a horizontal reference line;
a projection lens component having a center optical axis that is obliquely offset with respect to said horizontal reference line, wherein said projection lens component is disposed in front of said screen;
a first mirror disposed between said screen and said projection lens component; and
a second mirror disposed said first mirror and said screen for reflectively projecting an image reflected from said first mirror onto said screen, wherein said second mirror is not in parallel with said first mirror.

2. The projection lens system of a rear-projection type television according to claim 1 wherein said projection lens component is part of an optical engine that comprises at least one LCoS panel, wherein said LCoS panel is normal to said horizontal reference line but is offset with respect to an center optical axis of said optical engine.

3. The projection lens system of a rear-projection type television according to claim 2 wherein a center light beam emanated from a center of the projection lens component propagates along said center optical axis of said projection lens, and wherein said center light beam is first reflected by said first mirror, then reflected by said second mirror, and is eventually projected onto said screen at an incident angle that is smaller than 90°.

4. The projection lens system of a rear-projection type television according to claim 1 wherein said second mirror is disposed at an acute angle Θ₁ with respect to said image projection surface, said first mirror is disposed at an acute angle Θ₂ with respect to said image projection surface, and wherein angle Θ₁ ranges between 15° and 40°, inclusive.

5. The projection lens system of a rear-projection type television according to claim 4 wherein said angle Θ₁ is smaller than said angle Θ₂.
